(19) United States
(12) Patent Application Publication
(10) Pub. No.: US 2022/0044886 A1
(43) Pub. Date: Feb. 10, 2022

(54) KEY SWITCH HAVING COLLAPSIBLE BALANCING STAND

(71) Applicant: Caifeng HAN, Jingmen City, Hubei Province (CN)

(72) Inventor: Caifeng HAN, Jingmen City, Hubei Province (CN)

(21) Appl. No.: 17/298,619

(22) PCT Filed: Jan. 7, 2020
(86) PCT No.: PCT/CN2019/000003

§ 371 Date: May 31, 2021

(30) Foreign Application Priority Data
Dec. 21, 2018 (CN) 201811571922.2

(51) Int. Cl. H01H 13/14; H01H 13/20; H01H 13/70

(52) U.S. Cl. CPC H01H 13/14; H01H 13/70; H01H 13/20

(57) ABSTRACT

Proposed is a key switch haying a collapsible balance frame, comprising: a base, a movable plate, a balance frame, a transmission member and a key cap, wherein the movable plate is installed on the base and moves left and right along the base, wherein the balance frame is provided over the movable plate, wherein the balance frame comprises a first bracket and a second bracket arranged on a first side and a second side of the balance frame, respectively, wherein a lower end of the first bracket is connected to the movable plate, and a lower end of the second bracket is connected to the base, wherein a return spring is arranged horizontally, first and second ends of the return spring are (i) respectively connected to the first and the second brackets or (ii) respectively connected to the key cap and any one of the first bracket and the second bracket.

### CROSS-REFERENCE TO RELATED APPLICATION

This application is the National Stage of International Application No. PCT/CN2019/000003, filed on Jan. 7, 2019, which claims the benefit of and priority to Chinese Patent Application No. 201811571922.2 filed on Dec. 21, 2018, which are herein incorporated by reference in its entirety.

### TECHNICAL FIELD

The present invention relates to the technical field of key switches, in particular to a key switch having a collapsible balance frame.

### BACKGROUND OF THE INVENTION

Compared with a desktop computer, a laptop has a similar structure, but the advantages of the laptop are still quite apparent. Its main advantages are small size, lightweight and easy to carry. In general, portability is the biggest advantage of the laptop over the desktop computer, and it is very convenient to carry the laptop with you whether you leave for work or travel.

At present, ultra-light and ultra-thin have become the main development trends of the current laptops, which is mainly manifested in that the laptops are getting thinner and thinner. Many laptop vendors are forcing to reduce the height of the keyboard, and they use keyboards with a shorter key stroke to replace keyboards with a longer stroke. However, it is uncomfortable to press the key, the tactile is not well, and the tactile feedback is not enough after the key stroke is shortened. For example: Apple's MacBook Pro uses a keyboard with butterfly hinges, Although the key stroke is shortened and the height of the keyboard is reduced, customers generally report that the tactile of the keys feels not well. Moreover, since the structure of the butterfly hinges is extremely high precise, only a hair or a speck of dust falls into the keyboard, it will cause serious failures and affect the regular use of the computer. Therefore, making a convenient ultra-thin laptop keyboard has become a technical challenge in this field.

The ideal ultra-thin keyboard is a collapsible keyboard, that is, when you open the laptop screen, the keyboard and key caps rise upward; and when you close the laptop screen, the keyboard and the key caps collapse downward. In this way, the keyboard not only has an enough key stroke, but also can be ultra-thin. For example, U.S. Pat. No. 5,268,545 in 1993 and Chinese patent No. 1225686C in 2005 of Darfon Electronics Corp. have similar designs. However, there are obvious problems with these designs, that is, when the laptop is closed, the key caps on the keyboard need to be pressed down by the screen on the laptop. As we know, the force required for pressing each key cap is 60 grams, a keyboard has more than 100 keys, and the total force for pressing all key caps will be reached 6 kilograms. Imagine that when you close the laptop screens, the screen hinges need to provide 6 kilograms of downward force to press down the key caps. If it merely relies on increasing, the load of the laptop screen, it will not meet the development goals of the ultra-light and ultra-thin laptop, which undoubtedly increases the difficulty of key design and makes the key design go to a blind alley.

### SUMMARY OF THE INVENTION

In order to solve the problem of how the existing key switch can be collapsible and ultra-thin without increasing a folding force, the present invention provides a key switch having a collapsible balance frame.

The purpose of the present invention is realized by the following technical solutions: a key switch having a collapsible balance frame, comprising: a base, a movable plate, a balance frame, a transmission member and a key cap. The movable plate is installed on the base and moves left and right along the base. The balance frame is provided over the movable plate, and the balance frame comprises a first bracket and a second bracket arranged on a second side and a first side of the balance frame, respectively. A lower end of the first bracket is connected to the movable plate, and a lower end of the second bracket is connected to the base. The transmission member is provided over the first and the second brackets to move synchronously. A return spring is arranged horizontally. First and second ends of the return spring are respectively connected to the first and the second brackets or respectively connected to the key cap and any one of the first bracket and the second bracket. An upper end of the first bracket and an upper end of the second bracket are both connected to the key cap, and the key cap moves up and down along with the balance frame.

Preferably, in the key switch having the collapsible balance frame, the transmission member is a balance bar. An upper end of the balance bar is connected to a left side and a right side of the key cap respectively, and a lower end of the balance bar is movably connected to a bottom plate. The balance bar moves with the keycap on the bottom plate.

Preferably, in the key switch having the collapsible balance frame, the balance bar is U-shaped and left-right symmetric. The lower end of the balance bar passes through a buckle arranged horizontally on the bottom plate. The balance bar rotates in the buckle along with the key cap.

Preferably, in the key switch having the collapsible balance frame, the transmission member includes a connecting tooth and a connecting groove. The connecting tooth is inserted into the connecting groove. A third bracket is provided with the connecting tooth, and the fourth bracket is provided with the connecting groove. The connecting groove is squeezed by the connecting tooth to make the third and the fourth brackets move synchronously.

Preferably, in the key switch having the collapsible balance frame, the third bracket and the fourth bracket are both provided with the connecting tooth and the connecting groove. The connecting tooth is provided on the third bracket and is meshed the connecting groove provided on the fourth bracket, and the connecting groove provided on the third bracket is meshed the connecting tooth provided on the fourth bracket.

Preferably, in the key switch having the collapsible balance frame, the transmission member includes side teeth and side grooves. The third bracket is provided with the side tooth, and the fourth bracket is provided with the side groove. The side tooth is inserted into the side groove. The side groove is squeezed by the side tooth to make the third and the fourth brackets move synchronously.

Preferably, in the key switch having the collapsible balance frame, the transmission member includes a pin and a slot. The third bracket is provided with the pin and the fourth bracket is provided with the slot. The pin is inserted into the slot. The slot is squeezed by the pin to make the third and the fourth brackets move synchronously.

Preferably, in the key switch having the collapsible balance frame, the key cap is equipped with a bump. The bump is located over the return spring. The first and the second ends of the return spring are respectively connected to the first bracket and the second bracket. A middle part of the first bracket and a middle part of the second bracket are both provided with a first clamping groove and a second clamping groove. First and second hooks are located at the first and the second ends of the return spring and are respectively connected to the first and the second damping groove, and the return spring is connected to the balance frame through the first and the second hooks.

Preferably, in the key switch having the collapsible balance frame, an elastomer is installed on the base. A bottom end of the elastomer is connected to the base. The elastomer is located under the first bracket. When the first bracket rotates to press on the elastomer, the elastomer releases an elastic potential energy to push the first bracket upward.

Preferably, in the key switch having the collapsible balance frame, the base is provided with a limit buckle and a guide groove. Movable rods are provided on the movable plate and is inserted into the limit buckle and then clamped on the guide groove. The movable rods are provided with a second jack hole, and the movable plate is connected to the lower end of first bracket through the second jack hole.

Preferably, in the key switch having the collapsible balance frame, the movable rods comprise a plug-in rod and a limit rod integrally formed with the plug-in rod. The plug-in rod is clamped on the guide groove after the limit rod is inserted into the limit buckle. The movable rods are front-back symmetrically arranged on the movable plate, and the movable rods are respectively connected with the base.

Preferably, in the key switch having the collapsible balance frame, the base comprises a bottom plate that is fixedly connected to the base. The bottom plate is provided with a first jack hole. The lower end of the second bracket is inserted into the first jack hole for retaining, and the base is connected to the second bracket through the first jack hole.

Preferably, in the key switch having the collapsible balance frame, a trigger switch is installed in the base. The trigger switch is one of a photoelectric switch, a membrane switch, a mechanical switch and a magnetic induction switch. When the key cap is pressed downward, a chip is triggered according to a signal or a signal change detected by the trigger switch.

Preferably, in the key switch having the collapsible balance frame, the trigger switch is the photoelectric switch. A light barrier is arranged below the second bracket. When the key cap is pressed downward, the light barrier is inserted into a photoelectric, switch, and the light barrier blocks an emitter and a receiver of the photoelectric switch. The chip is triggered according to the change of an optical signal detected by the photoelectric switch.

Preferably, in the key switch having the collapsible balance frame, the trigger switch is the membrane switch. The membrane switch is located under the second bracket. When the key cap is pressed downward, the second bracket moves downward along with the key cap to press the membrane switch, so that the membrane switch's two poles make contact and close the circuit, and the chip is triggered according to an electrical signal detected by the membrane switch.

Preferably, in the key switch having the collapsible balance frame, the trigger switch is the magnetic induction switch, which comprises a magnet and a magnetic sensor. The magnet is built in the key cap. When the key cap is pressed downward, the magnet moves downward along with the key cap. A circuit board of the base is provided with the magnetic sensor. The magnetic sensor senses a magnetic force of the magnet, and the chip is triggered according to the change of a magnetic signal detected by the magnetic induction switch.

An intelligent device comprising the key switch having the collapsible balance frame is provided. The intelligent device includes a mobile phone, an intelligent electric appliance, etc. The key switch is installed in a keyboard base, and the keyboard base is rotationally connected to a flip cover. The flip cover is connected to a conversion member, and the conversion member rotates with the flip cover. The conversion member is connected to a movable plate, and the movable plate is driven to move horizontally by a rotation of the conversion member.

Preferably, in the intelligent device comprising the key switch having the collapsible balance frame, the conversion member is a shift shaft. The shift shaft is installed on the flip cover and rotates with the flip cover. An end portion of the shift shaft is provided with a clamp block. The chimp block extends from a curved surface at a right end of the shift shaft to a left end of the shift shaft. The shift shaft is connected to the movable plate through the clamp block, and the movable plate moves left and right with a rotation of the shift shaft.

Compared with the existing technology, the present invention has the following beneficial effects: in the present invention, when the movable plate is pushed left and right, the balance frame rotates along with the movable plate, and the key cap moves up and down accordingly under an action of the transmission member, thereby achieving collapsibility of a key. When the key switch is collapsed, the balance frame does not interfere with the return spring, which greatly reduces the force required for collapsing and effectively solves the problem of an ultra-thin keyboard key switch. In addition, the key switch of the present invention ensures smoothness of an up-and-down movement of the key cap, and avoids problems of misalignment or jamming of the key cap caused by pressing the periphery of the key cap, poor trigger sensitivity, and the like.

### BRIEF DESCRIPTION OF THE DRAWINGS

In order to illustrate the technical solution in the embodiments of the present invention or the existing technology more clearly, the accompanying drawings used in the description of the embodiments or the existing technology are briefly introduced below. It is apparent that the drawings described below are only an embodiment of the present invention. For those skilled in the art, other drawings may be obtained in accordance with these drawings without any creative work.

FIG. 1 is a schematic structural diagram of a key switch in an embodiment 1 of the present invention;

FIG. 2 is an assembly effect diagram of the key switch in the embodiment 1 of the present invention;

FIG. 3 is trigger state diagram of the key switch in the embodiment 1 of the present invention;

FIG. 4 is an exploded structural diagram of the key switch in the embodiment 1 of the present invention;

FIG. 5 is a collapsing principle diagram of the key switch in the embodiment 1 of the present invention;

FIG. 6 is a triggering principle diagram of the key switch in the embodiment 1 of the present invention;

FIG. 7 is a schematic structural diagram of a computer comprising a key switch in an embodiment 2 of the present invention;

FIG. 8 is a diagram of an opening and closing principle of the computer comprising the key switch in the embodiment 2 of the present invention;

FIG. 9 is a structural diagram of a shift shaft in the computer comprising the key switch in the embodiment 2 of the present invention;

FIG. 10 is an assembly effect diagram of a key switch in an embodiment 3 of the present invention;

FIG. 11 is an exploded structural diagram of the key switch in the embodiment 3 of the present invention;

FIG. 12 is an assembly effect diagram of a key switch in an embodiment 4 of the present invention;

FIG. 13 is an exploded structural diagram of the key switch in the embodiment 4 of the present invention;

FIG. 14 is an assembly effect diagram of a key switch in an embodiment 5 of the present invention;

FIG. 15 is an exploded structural diagram of the key switch in the embodiment 5 of the present invention;

FIG. 16 is an assembly effect diagram of a key switch in an embodiment 7 of the present invention;

FIG. 17 is an exploded structural diagram of the key switch in the embodiment 7 of the present invention;

FIG. 18 is an assembly effect diagram of a key switch in an embodiment 8 of the present invention;

FIG. 19 is a front exploded view of the key switch in the embodiment 8 of the present invention;

FIG. 20 is a reverse exploded view of the key switch in the embodiment 8 of the present invention;

FIG. 21 is an exploded structural diagram of a key switch in an embodiment 9 of the present invention;

FIG. 22 is an assembly effect diagram of the key switch in the embodiment 9 of the present invention.

In the drawing: 1 base, 11 buckle, 12 elastomer, 13 bottom plate, 14 first jack hole, 15 limit buckle, 16 guide groove, 17 circuit board; 2 movable plate, 21 movable rod, 22 second jack hole, 23 plug-in rod, 24 limit rod, 25 connecting rod; 3 balance frame, 31 first bracket, 32 second bracket, 31a third bracket, 32a fourth bracket, 33 clamping groove, 34 light barrier, 35 protrusion; 4 key cap, 41 bump, 42 magnet; 5 return spring, 51 hook; 6 transmission member, 61 balance bar, 62 pin, 63 slot, 64 side tooth, 65 side groove; 7 trigger switch, 71 photoelectric switch, 72 membrane switch, 73 pressure sensitive adhesive, 74 isolation plate, 75 contact; 76 magnetic sensor; 8 key switch, 81 keyboard base, 82 computer screen, 9 shift shaft, 91 clamp block.

### DETAILED DESCRIPTION

For a better understanding of the present invention, the technical solutions of the present invention will be described clearly and completely through specific embodiments of the present invention. It is obvious that the described embodiments are only some embodiments of the present invention, rather than all embodiments. Based on the embodiments in the present invention, all other embodiments obtained by those skilled in the art without creative work are within the protection scope of the present invention.

Embodiment 1

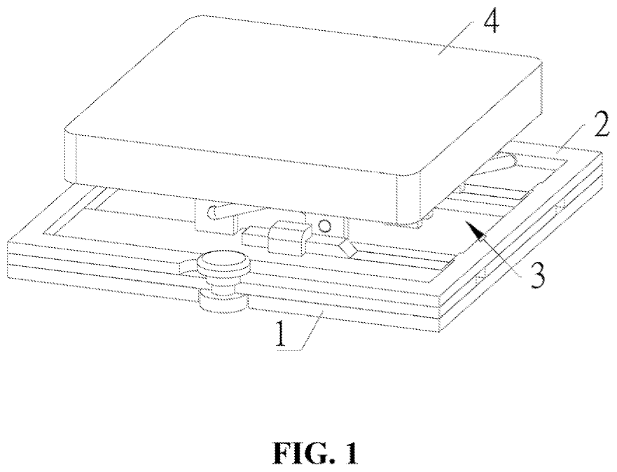

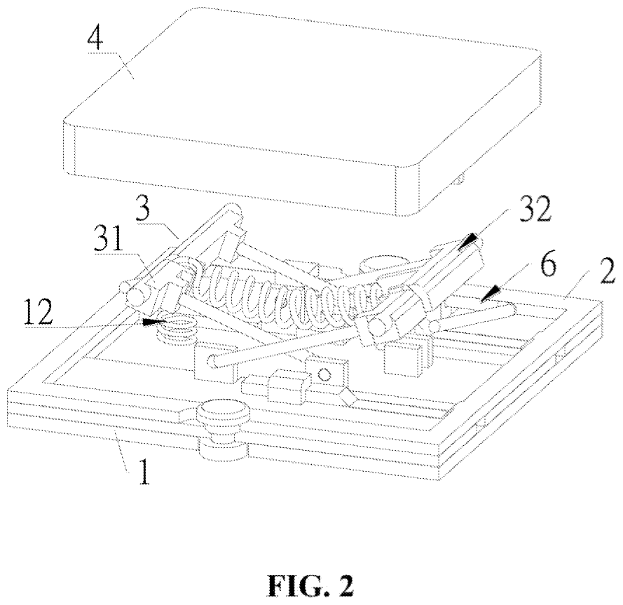

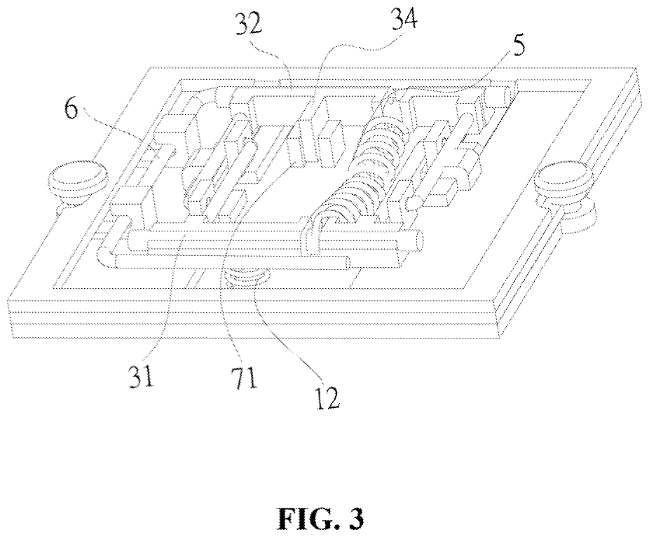

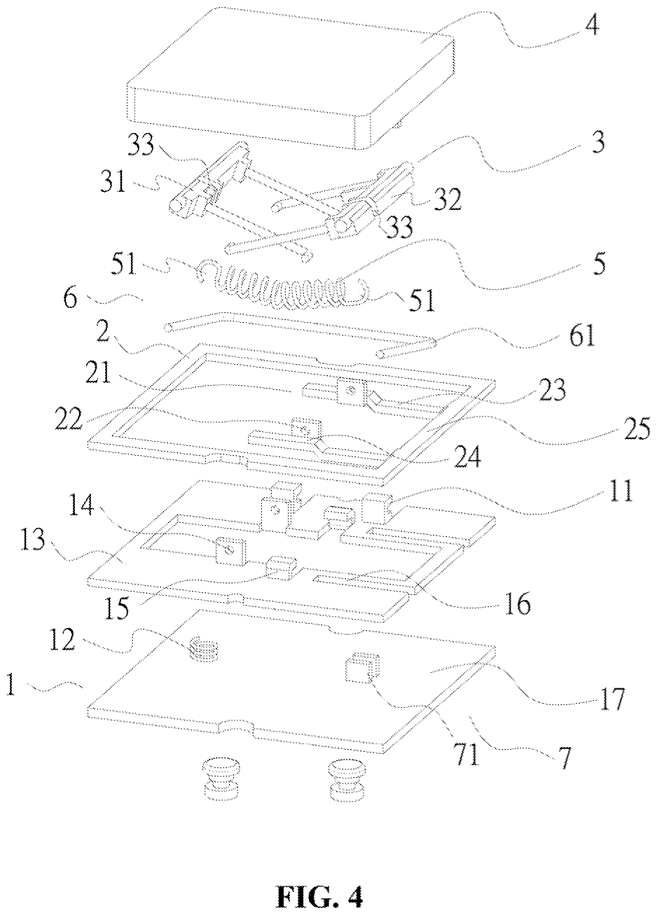

FIGS. 1 to 6 show a key switch having a collapsible balance frame. The key switch comprises a base (1), a movable plate (2), a balance frame (3), a transmission member (6) and a key cap (4). The movable plate (2) is installed on the base (1) and moves left and right along the base (1). The balance frame (3) is connected to the movable plate (2), and the balance frame (3) comprises a first bracket (31) and a second bracket (32). A lower end of the first bracket (31) is connected to the movable plate (2), and the movable plate (2) drives the first bracket (31) to rotate. A lower end of the second bracket (32) is connected to the base (1), and the transmission member (6) is provided over the first bracket (31) and the second bracket (32) to move synchronously. A return spring is connected between the first bracket (31) and the second bracket (32). An upper end of the first bracket (31) and an, upper end of the second bracket (32) are both installed on the key cap (4), and the key cap (4) moves up and down along with the balance frame (3).

A bump (41) is equipped in the key cap (4), and the bump (41) is located over the retina spring (5). When the key cap (4) is pressed, the return spring (5) is squeezed by the bump (41), and the return spring (5) is stretched downward, so that the first bracket (31) and the second bracket (32) connected to the return spring (5) and rotated, thus the tactile of pressing the key cap (4) may change from tight to loose then to tight, thus increasing the tactile feedback of the key switch.

The return spring (5) is arranged horizontally. First and second ends of the return spring (5) are respectively connected to the first bracket (31) and the second bracket (32). A middle part of the first bracket (31) and a middle part of the second bracket (32) are both provided with first and second clamping groove (33). First and second hooks (51) are located at the first and the second ends of the return spring (5) are respectively connected to the first and the second clamping groove (33). The return spring (5) is connected to the first bracket (31) and the second bracket (32) respectively through the first and the second hooks (51).

The transmission member (6) is a balance bar (61), and the balance bar (61) is arranged between the key cap (4) and the base (1). The balance bar (61) is U-shaped. The upper ends of the balance bar (61) are connected to the left and right sides of the key cap (4) respectively, and the lower ends of the balance bar (61) pass through a buckle (11) arranged horizontally on the bottom plate (13). The balance bar (61) rotates in the buckle (11) along with the key cap (4). During collapsing, under an act of the U-shaped balance bar (61), the second bracket (32) moves with the rotation of the first bracket (31) which ensures smoothness of an up-and-down movement of the key cap (4), and avoids problems of misalignment or jamming of the key cap caused by pressing the periphery of the key cap (4), poor trigger sensitivity, and the like.

An elastomer (12) is installed on the base (1), and the elastomer (12) is a spring. A bottom end of the elastomer (12) is connected to the base (1). The elastomer (12) is located under the first bracket (31). When the first bracket (31) rotates to press on the elastomer (12), the elastomer (12) releases an elastic potential energy to push the first bracket (31) upward. The base (1) comprises a bottom plate (13), and the bottom plate (13) is fixedly connected to the base (1). The bottom plate (13) is provided with a first jack hole (14), and the lower end of the second bracket (32) is inserted into the first jack hole (14) for retaining. The bottom plate (13) is connected to the second bracket (32) through the first jack hole (14). The bottom plate (13) is further provided with a limit buckle (15) and a guide groove (16). Movable rods (21) are provided on the movable plate (2) is inserted into the limit buckle (15) and then clamped on the guide groove (16).

The movable rods (21) of the movable plate (2) are provided with a second jack holes (22), and the movable plate (2) is connected to the first bracket (31) through the second jack. holes (22). The movable rods (21) comprises plug-in rods (23) and limit rods (24) integrally formed with the plug-in rods (23). After the limit rods (24) are inserted into the limit hackles (15), the plug-in rods (23) are clamped on the guide grooves (16). The movable rods (21) are front-back symmetrically arranged on the movable plate (2), and the movable rods (21) are connected to the base (1) respectively.

A trigger switch (7) is also installed in the base (1). The trigger switch (7) is a photoelectric switch. A light barrier (34) is arranged below the second bracket (32). When the key cap (4) is pressed downward, the light barrier (34) is inserted into a photoelectric switch (71), and the light barrier (34) blocks an emitter and a receiver of the photoelectric switch (71). The photoelectric switch detects the change of an optical signal and transmits it to a chip, so that the chip is triggered.

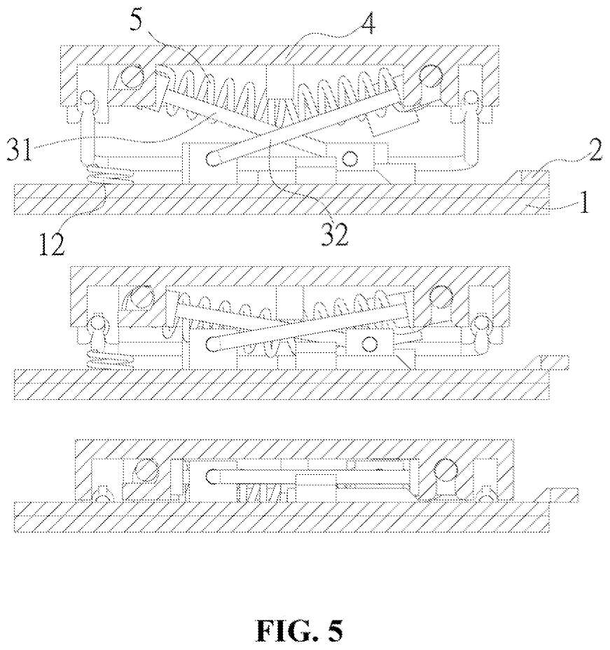

Working principle of collapsing: as shown in FIG. 5, when the movable plate (2) is pulled to the right, since the lower end of the first bracket (31) is connected to the movable plate (2), the movable plate (2) drives the first bracket (31) to rotate downward. Since the balance bar (61) is arranged between the key cap (4) over the first bracket (31) and the base (1), the second bracket (32) rotates downward accordingly under the action of the balance bar (61). Therefore, the key cap (4) connected to the first bracket (31), and the second bracket (32) moves downward. The downward movement of the key cap (4) is achieved by pulling the movable plate (2) to the right.

On the contrary, n the key cap (4) moves downward, the movable plate (2) is pushed to the left. Since the lower end of the first bracket (31) is connected to the movable plate (2), the movable plate (2) drives the first bracket (31) to rotate upward, Since the balance bar (61) is arranged between the key cap (4) over the first bracket (31) and the base (1), the second bracket (32) rotates upward accordingly under the action of the balance bar (61). Therefore, the key cap (4) connected to the first bracket (31) and the second bracket (32) moves upward, which is achieved by pushing the movable plate (2) to the left.

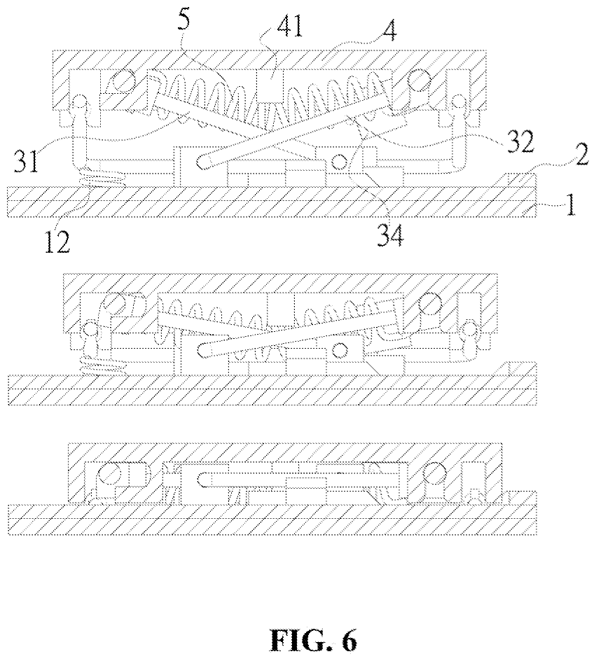

Working principle of triggering: as shown in FIG. 6, when the key cap (4) is pressed by a finger in its up position, the balance frame (3) is pressed down with the key cap (4). The first bracket (31) and the second bracket (32) rotate to two sides at the same time, so that the return spring (5) connected between the first bracket (31) and the second bracket (32) is stretched, and the first bracket (31) is pressed to squeeze the elastomer (12), while the light barrier (34) on the second bracket (32) is inserted between the emitter and the receiver of the, photoelectric switch (71). The light barrier (34) blocks the optical signal of the photoelectric switch (71). Therefore, the chip is triggered according to the change of the optical signal detected by the photoelectric switch, displaying corresponding information and realizing a key input function.

When the key cap (4) is released, the stretched return spring (5) releases the elastic potential energy, which makes the first bracket (31) and the second bracket (32) rotate toward the middle. At the same time, the elastomer (12) located under the first bracket (31) pushes the first bracket (31) upward. Under a joint action of the return spring (5) and the elastomer (12), the balance frame (3) moves upward to lift the key cap (4), and the light barrier (34) moves upward, and the key input process is completed.

Embodiment 2

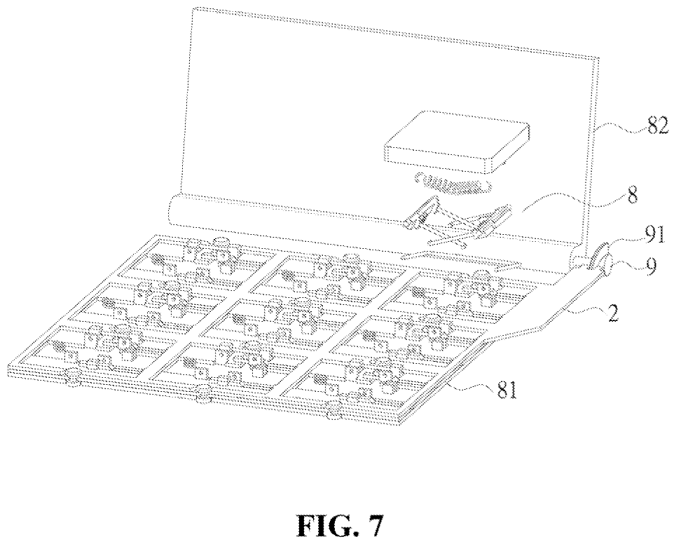

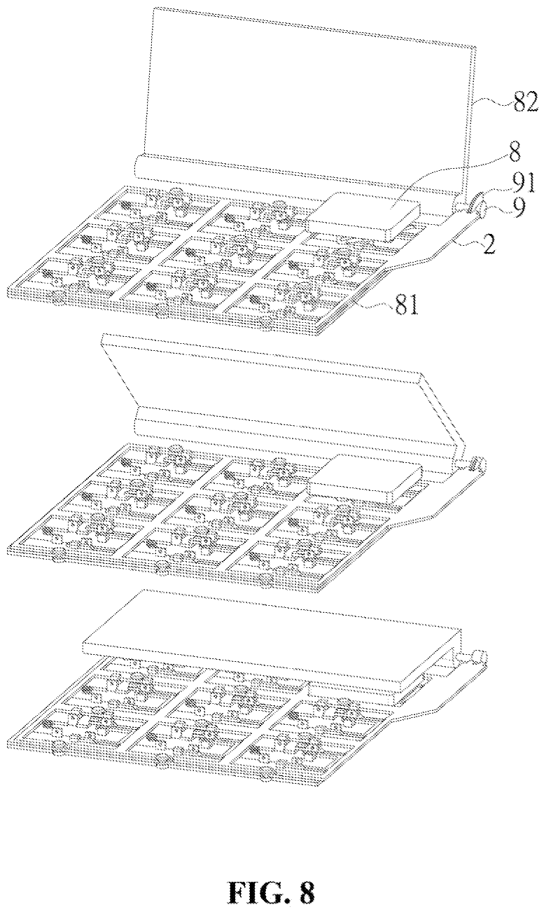

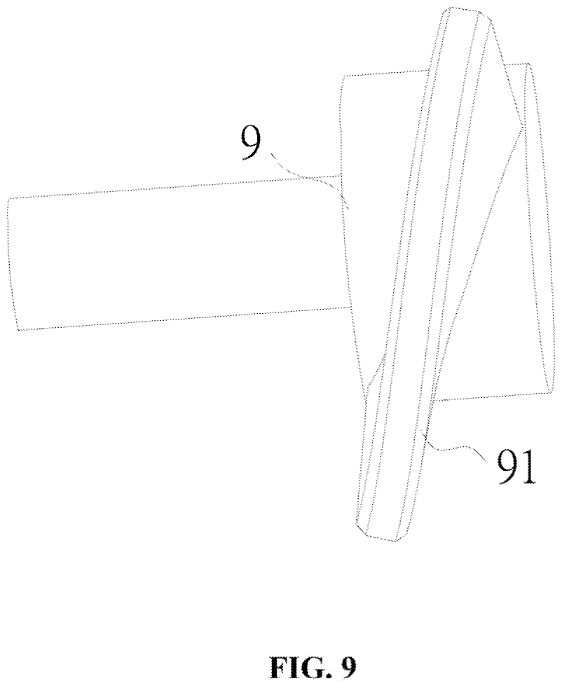

FIGS. 7 to 9 show a computer comprising a key switch having a collapsible balance frame. Based on the embodiment (1), the key switch (8) is installed in a keyboard base (81). The keyboard base (81) is rotationally connected to a flip cover which is a computer screen (82). The computer screen (82) is connected to a conversion member, and the conversion member rotates with the computer screen (82) and is connected to a movable plate (2). The movable plate (2) is driven to move horizontally by a rotation of the conversion member.

The conversion member is a shift shaft (9), which is installed on the computer screen (82) and rotates with the computer screen (82). An end of the shift shaft (9) is provided with a clamp block (91) which extends from a curved surface at a right end of the shift shaft (9) to a left end of the shift shaft. The shift shaft (9) is connected to the movable plate (2) through the clamp block (91). The clamp block (91) is clamped on the movable plate (2). The movable plate (2) moves left and right with a rotation of the shift shaft (9).

Opening and closing principle of computer: when the computer screen (82) is opened, the computer screen (82) rotates relative to the keyboard base (81). The shift shaft (9) is installed on the computer screen (82). The shift shaft (9) rotates with the computer screen (82). When the shift shaft (9) rotates, since the clamp block (91) on the shift shaft (9) extends from the curved surface at the right end of the shift shaft (9) to the left end of the shift shaft (9), and the movable plate (2) is clamped on the clamp block (91), the clamp block (91) drives the movable plate (2) to move to the left, and while the leftward movement of the movable plate (2) may cause the key cap (4) to move upward, thus realizing the function of rising the key cap (4) upwardly when the computer screen (82) is opened. On the contrary, when the computer screen (82) is closed, the computer screen (82) rotates in a reverse direction to cover the keyboard base (81). The shift shalt (9) rotates, and the shift shaft (9) drives the movable plate (2) to move to the right, and while the rightward movement of the movable plate may cause the key cap (4) to move downward, thus realizing the function of lowering and collapsing the key cap (4) when the computer screen (82) is opened.

Embodiment 3

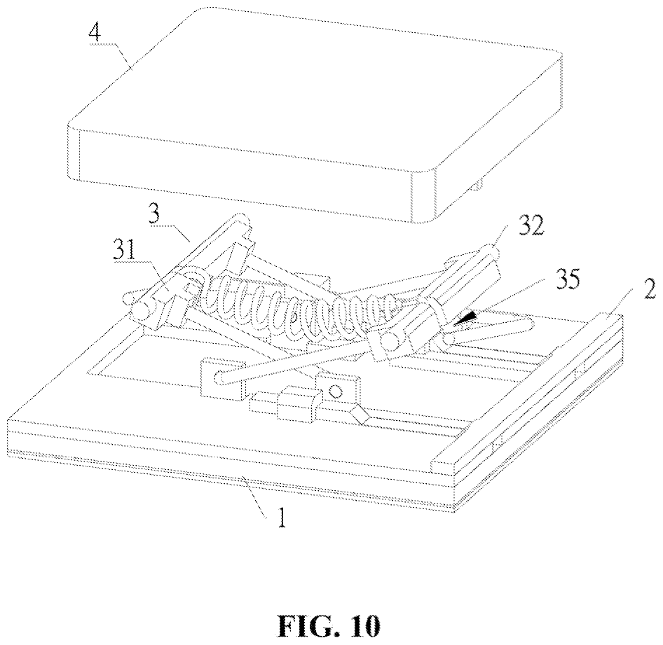

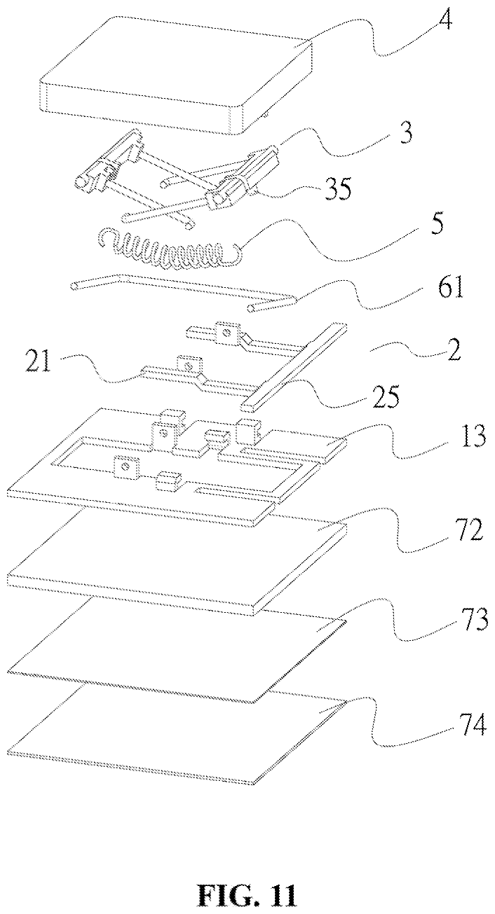

FIGS. 10 to 11 show a key switch having a collapsible balance frame. Based on the embodiment (2), the movable plate (2) of this embodiment includes movable rods (21) and a connecting rod (25). There are two movable rods (21), which are respectively connected to two ends of the connecting rod (25). The movable plate (2) is slidably connected with the base (1) through the movable rods (21) on the front and rear sides.

The trigger switch (7) is a membrane switch (72). The membrane switch (72) is installed on an isolation plate (74) through a pressure-sensitive adhesive (73). The isolation plate (74) installed with the membrane switch (72) is fixed in the base (1). The bottom plate (13) is located over the membrane switch (72). A contact of the membrane switch (72) passes through the bottom plate (13) and is located under the second bracket (32). The second bracket (32) is provided with a downward protrusion (15). When the key cap (4) is pressed downward, the protrusion (35) moves downward with the second bracket (32) and presses the contact of the membrane switch (2), so that the membrane switch's (72) two poles make contact and close the circuit. The chip is triggered according to an electrical signal detected by the membrane switch (72), displaying corresponding information and realizing the key input function.

Embodiment 4

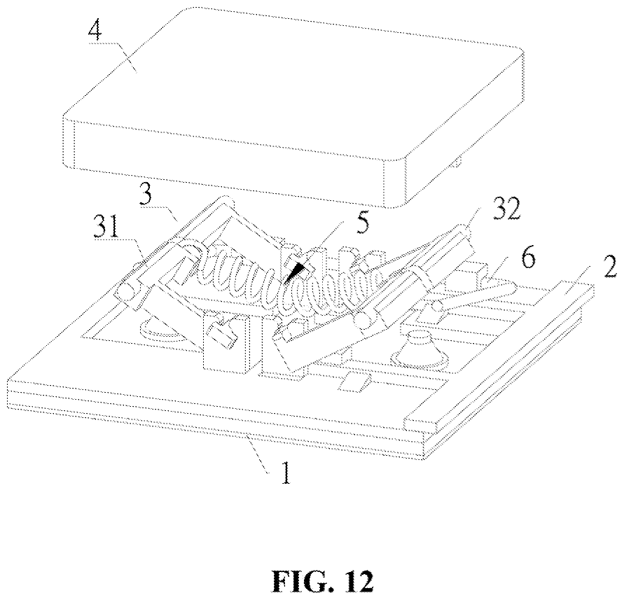

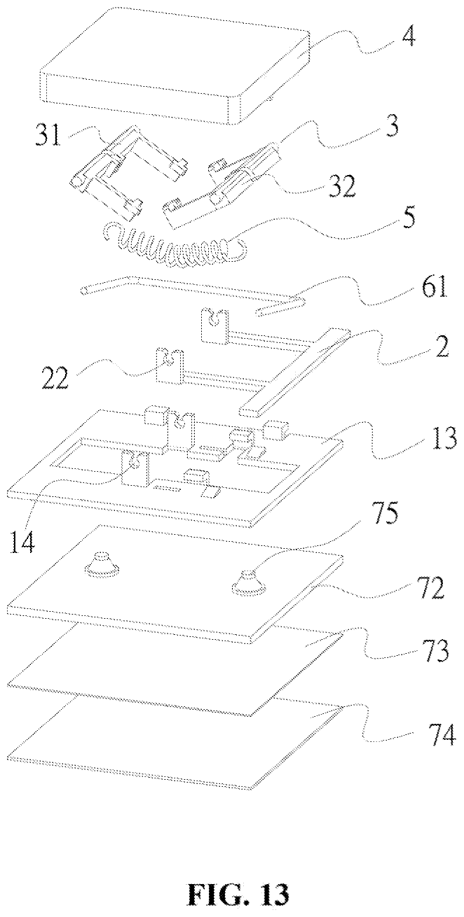

FIGS. 12 to 13 show a key switch having a collapsible balance frame. Based on the embodiment (3), in this embodiment, the lower end of the first bracket (31) is retained on the first jack hole (14) of the base (1), and the lower end of the second bracket (32) is inserted into the second jack hole (22) on the movable rods (21) and retained.

The membrane switch (72) is provided with two upwardly convex contacts (75). The contacts (75) are arranged on the membrane switch (72) left-right symmetrically. The two contacts (75) respectively pass through the bottom plate (13) and are located under the first bracket (31) and the second bracket (32). When the key cap (4) is pressed downward, the first bracket (31) and the second bracket (32) move downward along with the key cap (4) and press the contacts (75) of the membrane switch (72), so that the membrane switch's (72) two poles make contact and close the circuit. The chip is triggered according to the electrical signal detected by the membrane switch (72), displaying corresponding information and realizing the key input function.

When collapsing, the movable plate (2) is pushed to the left, and the movable plate (2) drives the second bracket (32) to rotate downward. Under the action of the balance bar (61), the balance bar (61) drives the first bracket (31) to move along with the second bracket (32). The first bracket (31) and the second bracket (32) drive the key cap (4) over them to rotate upward, thus realizing the collapsing of the key cap (4).

Embodiment 5

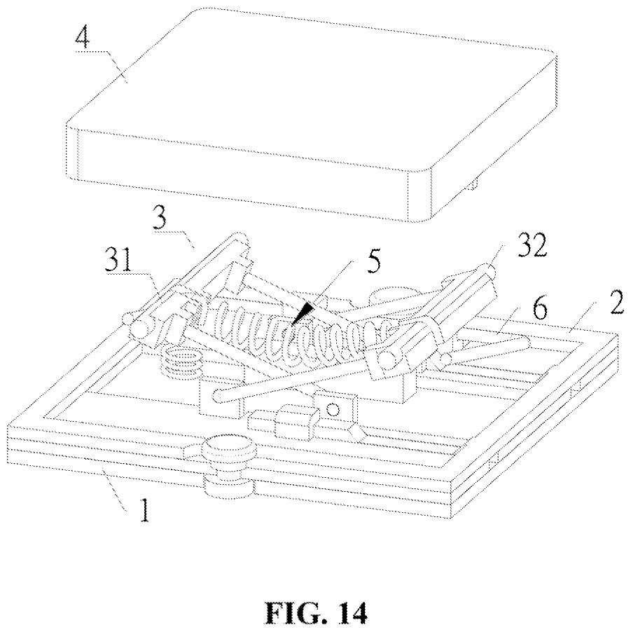

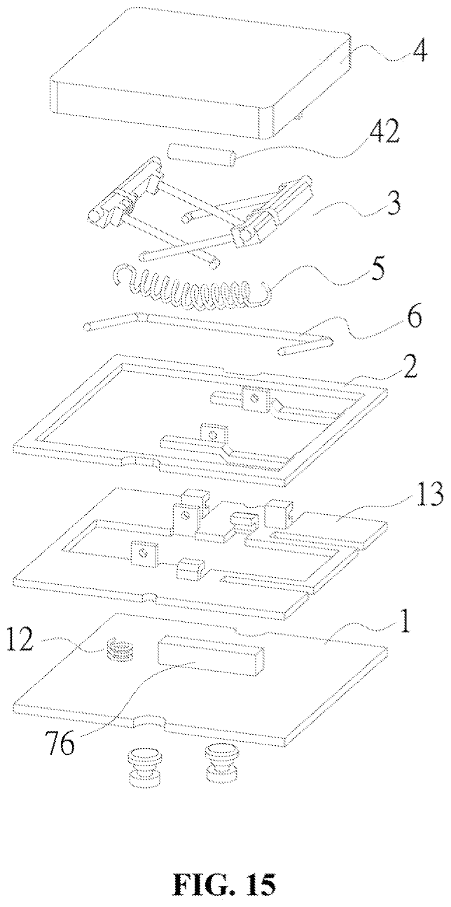

FIGS. 14 to 15 show a key switch having a collapsible balance frame. Based on the embodiment (1), the trigger switch (7) is a magnetic induction switch, which comprises a magnet (42) and a magnetic sensor (76). The magnet (42) is built in the key cap (4). When the key cap (4) is pressed downward, the magnet (42) moves downward along with the key cap (4). A circuit board (17) of the base (1) is provided with the magnetic sensor (76). The magnetic sensor (76) senses a magnetic force of the magnet (42). The chip is triggered according to the change of a magnetic signal detected by the magnetic induction switch, displaying corresponding information and realizing the key input function.

Embodiment 6

A key switch having a collapsible balance frame. Based on the embodiment (1), a first end of the return spring (5) is connected to the first bracket (31), and a second end of the return spring (5) is connected to the key cap (4) over the second bracket (32).

When the key cap (4) is pressed by a finger when triggering, the balance frame (3) is pressed downward with the key cap (4). The first bracket (31) and the second bracket (32) rotate to two sides at the same time, and the return spring (5) connected between the first bracket (31) and the key cap (4) is stretched. When the key cap (4) is released, the stretched return spring (5) releases the elastic potential energy, so that the first bracket (31), the second bracket (32) and the key cap (4) are reset.

Embodiment 7

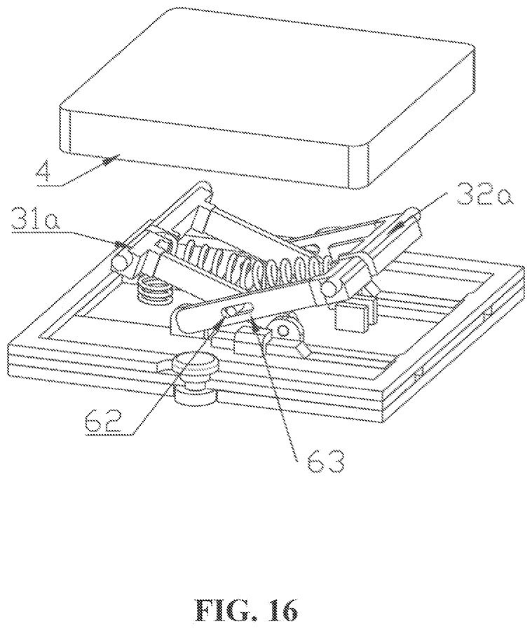

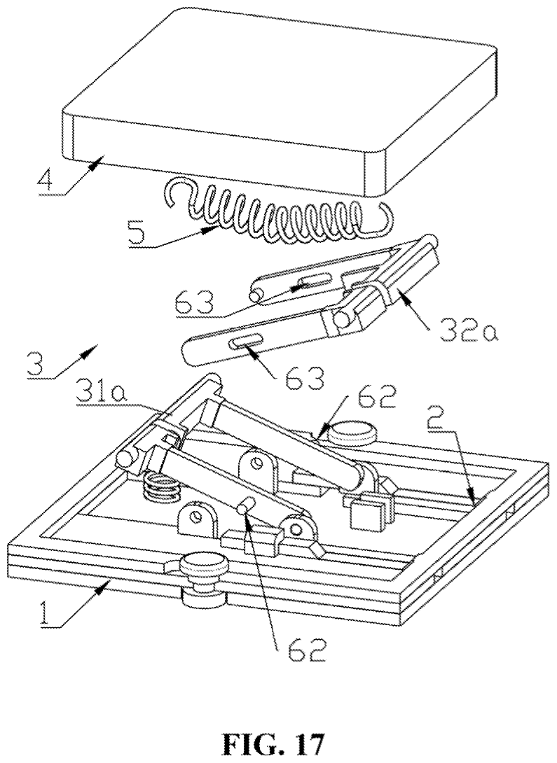

FIGS. 16 to 17 show a key switch having a collapsible balance frame. Based on the embodiment (1), the transmission member (6) of this embodiment includes a pin (62) and a slot (63). Two sides of the third bracket (31a) are provided with the pins (62), and two sides of the fourth bracket (32a) are provided with the slots (63). The pins (62) on the third bracket (31a) are inserted into the slots (63) of the fourth bracket (32a). The slots (63) are squeezed by the pins (62) on both sides to make the third bracket (31a) and the fourth bracket (32a) move synchronously.

Working principle of collapsing: when the movable plate (2) is pulled to the right, since the lower end of the third bracket (31a) is connected to the movable plate (2), the movable plate (2) drives the third bracket (31a) to rotate downward. Since the third bracket (31a) and the fourth bracket (32a) are connected through the pins (62) and slots (63), the third bracket (31a) drives the fourth bracket (32a) to rotate downward accordingly. The key cap (4) is connected to the third bracket (31a) and the fourth bracket (32a) moves downward. The downward movement of the key cap (4) is achieved by pulling the movable plate (2) to the right On the contrary, when the key cap (4) moves downward, the movable plate (2) is pushed to the left, and the third bracket (31a) drives the fourth bracket (32a) to rotate upward. The upward movement of the key cap (4) is achieved by pushing the movable plate (2) to the left.

Embodiment 8

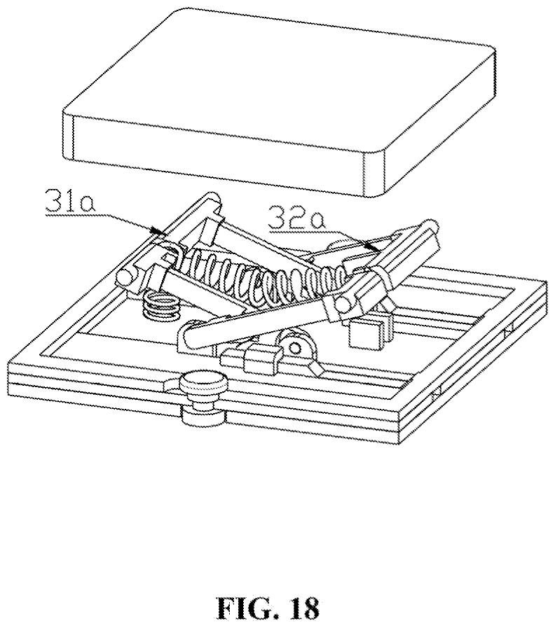

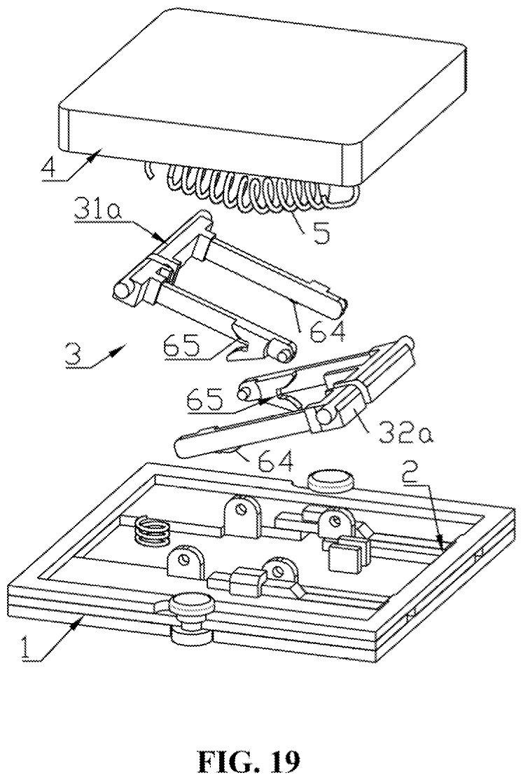

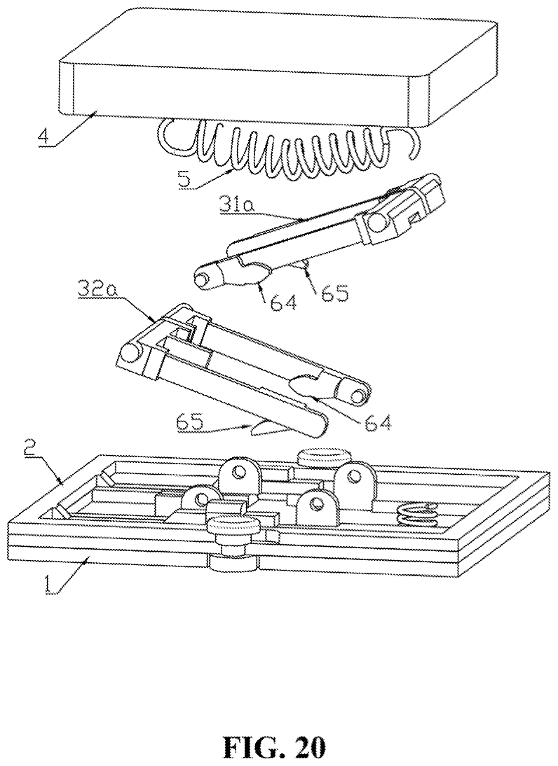

FIGS. 18 to 20 show a key switch having a collapsible balance frame. Based on the embodiment (7), the transmission member (6) of this embodiment includes a side tooth (64) and a side groove (65). The third bracket (31a) and the fourth bracket (32a) are both provided with the side tooth (64) and the side groove (65). The side tooth (64) on the third bracket (31a) is inserted into the side groove (65) on the fourth bracket (32a), and the side tooth (64) on the fourth bracket (32a) is inserted into the side groove (65) on the third bracket (31a). The side grooves (65) are squeezed by the side teeth (64) on both sides to make the third bracket (31a) and the fourth bracket (32a) move synchronously. The working principle is consistent with that of the embodiment (7).

Embodiment 9

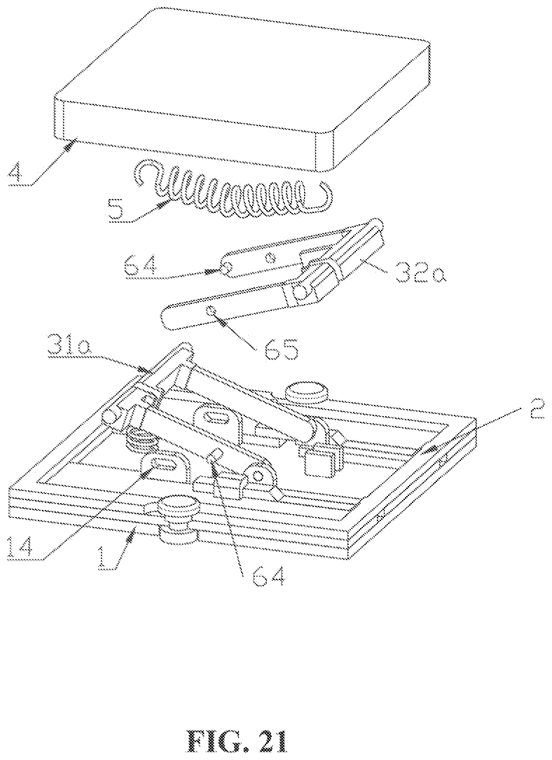

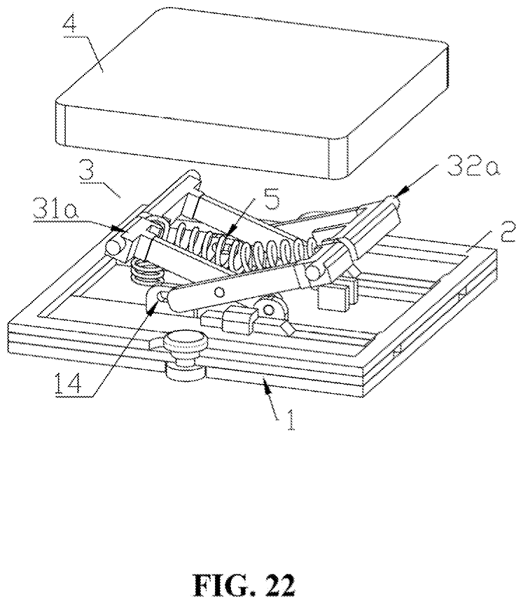

FIGS. 21 to 22 show a key switch having a collapsible balance frame. Based on the embodiment (8), the transmission member (6) of this embodiment includes the side tooth (64) and the side groove (65). The side tooth (64) is inserted into the side groove (65) and retained. The transmission member (6) drives the third bracket (31a) and the fourth bracket (32a) to move synchronously through the cooperation between the side tooth (64) and the side groove (65). The first jack hole (14) is a movable hole. The lower end of the fourth bracket (32a) is inserted into the first jack hole (14), and the fourth bracket (32a) may move left and right in the first jack hole (14).

When collapsed, the third bracket (31a) drives the fourth bracket (32a) move left and right in the first jack hole (14) through the transmission member (6). The fourth bracket (32a) and the third bracket (31a) rotate synchronously through the left and right movement of the fourth bracket (32a), thus driving the key cap (4) over the balance frame (3) to move up and down.

The above description is only preferred embodiments of the present invention and is not intended to limit the present invention. Any modifications, equivalent substitutions improvements or the like made within the spirit and principles of the present invention are included in the protection scope of the present invention.

1-10. (canceled)

1. A key switch having a collapsible balance frame, comprising:
a base, a movable plate, a balance frame, a transmission member and a key cap,
wherein the movable plate is installed on the base and moves left and right along the base,
wherein the balance frame is provided over the movable plate,
wherein the balance frame comprises a first bracket and a second bracket arranged on a second side and a first side of the balance frame, respectively,
wherein a lower end of the first bracket is connected to the movable plate, and a lower end of the second bracket is connected to the base,
wherein a return spring is arranged horizontally,
wherein first end of the return spring are respectively connected to any one of the first bracket and the second bracket,
wherein an upper end of the first bracket and an upper end of the second bracket are both connected to the key cap,
wherein the key cap moves up and down along with the balance frame,
wherein the base comprises a bottom plate,
wherein an elastomer passes through the bottom plate and is connected to the base,
wherein the elastomer is located under the first bracket,
wherein, when the first bracket rotates to press on the elastomer, the elastomer releases an elastic potential energy to push the first bracket upward.

12. The key switch haying the collapsible balance frame according to claim 1,
wherein the transmission member is a balance bar,
wherein an upper end of the balance bar is connected to a left side and a right side of the key cap respectively, and a lower end of the balance bar is movably connected to a bottom plate;
wherein the balance bar is U-shaped and left-right symmetric,
wherein the lower end of the balance bar passes through a buckle arranged horizontally on the bottom plate,
wherein the balance bar rotates in the buckle along with the key cap.

13. The key switch having the collapsible balance frame according to claim 1,
wherein the transmission member includes a connecting tooth and a connecting groove,
wherein the third bracket and the fourth bracket are both provided with the connecting tooth and the connecting groove,
wherein the connecting tooth is inserted into the connecting groove,
wherein the connecting tooth is provided on the third bracket and is meshed the connecting groove provided on the fourth bracket,
wherein the connecting groove provided on the third bracket is meshed the connecting tooth provided on the fourth bracket,
wherein the connecting groove is squeezed by the connecting tooth to make the third and the fourth brackets move synchronously with each other,
wherein the transmission member includes a side tooth and a side groove.

14. The key switch having the collapsible balance frame according to claim 1,
wherein the first and the second ends of the return spring are respectively connected to the first bracket and the second bracket,
wherein a middle part of the first bracket and a middle part of the second bracket are both provided with a first clamping groove and a second clamping groove,
wherein first and second hooks are respectively located at the first and the second ends of the return spring and are respectively connected to the first and the second clamping groove,
wherein the return spring, is connected to the balance flame through the first and the second hooks.

15. The key switch having the collapsible balance frame according to claim 1,
wherein the first and the second ends of the return spring are respectively connected to the key cap and art one of the first bracket and the second bracket.

16. The key switch having the collapsible balance frame according to claim 1,
wherein the bottom plate is fixedly connected to the base and is provided with a first jack hole, and
wherein the base is connected to the second bracket through the first jack hole,
wherein the base is provided with a limit buckle and a guide groove,
wherein a movable rod is provided on the movable plate and is inserted into the limit buckle and then clamped on the guide groove,
wherein the movable rod is provided with a second jack hole,
wherein the movable plate is connected to the first bracket through the second jack hole,
wherein the movable rod is symmetrically arranged on the movable plate side by side,
wherein the movable rod is movably connected with the base.

17. The key switch having the collapsible balance frame according to claim 1,
wherein a trigger switch is installed in the base,
wherein the trigger switch is one of a photoelectric switch, a membrane switch, a mechanical switch and a magnetic induction switch,
wherein, when the key cap is pressed downward, a chip is triggered according to a signal or a signal change detected by the trigger switch.

18. An intelligent device comprising:
the key switch having the collapsible balance frame according to claim 1; and
a keyboard base,
wherein the key switch is installed in the keyboard base,
wherein the keyboard base is rotationally connected to a flip cover,
wherein the flip cover is connected to a conversion member,
wherein the conversion member rotates with the flip cover,
wherein the conversion member is connected to a movable plate,
wherein the movable plate is driven to move horizontally by a rotation of the conversion member.

19. The intelligent device according to claim 8,
wherein the conversion member is a shift shaft,
wherein the shift shaft is installed on the flip cover and rotates with the flip cover,
wherein an end portion of the shift shaft is provided with a damp block,
wherein the clamp block extends from a curved surface at a right end of the shift shaft to a left end of the shift shaft,
wherein the shift shaft is connected to the movable plate through the clamp block,
wherein the movable plate moves left and right with a rotation of the shift shaft.
